(19) United States
(12) Patent Application Publication
(10) Pub. No.: US 2026/0261082 A1
(43) Pub. Date: Sep. 3, 2026

(54) SHIELD CONNECTOR

(71) Applicant: SUMITOMO WIRING SYSTEMS, LTD., Mie (JP)

(72) Inventors: Kazuya TAKEUCHI, Mie (JP); Norihito HASHIMOTO, Mie (JP); Kazuya KOBAYASHI, Mie (JP)

(21) Appl. No.: 18/833,921

(22) PCT Filed: Jan. 12, 2023
(86) PCT No.: PCT/JP2023/000545

§ 371 Date: Jul. 29, 2024

(30) Foreign Application Priority Data
Jan. 31, 2022 (JP) 2022-012597

(51) Int. Cl. H01R 13/6588; H01R 12/70; H01R 12/71; H01R 13/504

(52) U.S. Cl. CPC H01R 13/6588; H01R 12/707; H01R 12/7082; H01R 12/714; H01R 13/5045

(57) ABSTRACT

A shield connector (10) includes an inner conductor (11, 12), an outer conductor (13, 14, 15) that surrounds the inner conductor (11, 12), and a dielectric body (16, 17) displaced between the inner conductor (11, 12) and the outer conductor (13, 14, 15). A substrate-side outer shell body (14) includes a bottom surface (92), a back surface (93) intersecting the bottom surface (92), a mount portion (84 to 87) formed on the bottom surface (92) and bonded to a circuit substrate (200) through soldering, and a depressed portion (91) provided in an area extending from the back surface (93) to the bottom surface (92) and disposed in the bottom surface (92) in a vicinity of the mount portion (84 to 87).

### TECHNICAL FIELD

The present disclosure relates to a shield connector.

### BACKGROUND

A shield connector described in Patent Document 1 is a coaxial connector, and is installed on a circuit substrate. The shield connector includes a central contact (hereinafter, referred to as an “inner conductor”), an outer contact and an external conductor (hereinafter, referred to as an “outer conductor”) that surround the inner conductor, and an insulator (hereinafter, referred to as a “dielectric body”) disposed between the inner conductor and the outer conductor. The dielectric body maintains an insulated state between the inner conductor and the outer conductor. On the outer conductor, a mount leg that is inserted into a through hole of the circuit substrate is formed to protrude. A space between the mount leg and the internal surface of the through hole is filled with solder.

### PRIOR ART DOCUMENT

### Patent Document

Patent Document 1: JP 2008-181696 A

### SUMMARY OF THE INVENTION

### Problems to be Solved

Incidentally, in addition to the mount leg, a mount portion that is soldered to a surface of the circuit substrate may be formed on a bottom surface of the outer conductor. In this case, if the distance between an outer surface (back surface) of the outer conductor and the mount portion is long, when reflow-soldering is performed, there is the possibility that heat will not be transmitted to the mount portion, and solder (paste solder) for the mount portion will not melt. As a result, there is a risk that the mount portion will enter an unsoldered state.

In view of this, an object of the present disclosure is to provide a shield connector that can prevent a mount portion from entering an unsoldered state.

### Means to Solve the Problem

A shield connector according to the present disclosure includes; an inner conductor, an outer conductor that surrounds the inner conductor, and a dielectric body disposed between the inner conductor and the outer conductor, and the outer conductor includes a bottom surface, a back surface intersecting the bottom surface, a mount portion formed on the bottom surface and bonded to a surface of a circuit substrate through soldering, and a depressed portion provided in an area extending from the back surface to the bottom surface and disposed in the bottom surface in the vicinity of the mount portion.

### Effect of the Invention

According to the present disclosure, it is possible to provide a shield connector that can prevent a mount portion from entering an unsoldered state.

### BRIEF DESCRIPTION OF THE DRAWINGS

FIG. 1 is an exploded perspective view of a shield connector according to a first embodiment of the present disclosure.

FIG. 2 is a side cross-sectional view showing a state where the shield connector and a partner connector are fitted with each other.

FIG. 3 is a plane cross-sectional view showing a state where press-fitting blades of an outer conductor tube are locked on the inner peripheral surface of a through hole of an outer shell body, in an enlarged manner.

FIG. 4 is a transverse cross-sectional view showing a state where holding protrusion portions of the outer conductor tube comes into contact with the inner peripheral surface of the through hole of the outer shell body, in an enlarged manner.

FIG. 5 is a transverse cross-sectional view showing a state where housing-side holding protrusion portions of a housing come into contact with the outer peripheral surface of the outer conductor tube.

FIG. 6 is a transverse cross-sectional view showing contact protrusion portions of projection portions of the outer conductor tube come into contact with restriction portions, in an enlarged manner.

FIG. 7 is a cross-sectional view taken along the line A-A in FIG. 6.

FIG. 8 is a side cross-sectional view showing an internal structure of an outer conductor on the rear side of the shield connector, in an enlarged manner.

FIG. 9 is a rear view of the shield connector.

FIG. 10 is a rear view showing, in an enlarged manner, a state where a circuit substrate and mount portions are bonded to each other through soldering, and the state can be confirmed using a depressed portion.

FIG. 11 is a perspective view for describing a step of attaching the outer shell body to the housing.

FIG. 12 is a perspective view for describing a step of attaching a substrate-side outer shell body to the outer shell body.

FIG. 13 is a perspective view of the shield connector.

FIG. 14 is a front view of the housing.

FIG. 15 is a rear view of the housing.

FIG. 16 is a diagram of the bottom surface of the housing.

FIG. 17 is a perspective view of the outer shell body.

FIG. 18 is a rear view of the outer shell body.

FIG. 19 is a perspective view showing a through hole of the outer shell body in an enlarged manner.

FIG. 20 is a perspective view of the substrate-side outer shell body.

FIG. 21 is a perspective view of the substrate-side outer shell body as viewed from another angle.

FIG. 22 is a perspective view of an outer conductor tube.

FIG. 23 is a rear view of the outer conductor tube.

### DETAILED DESCRIPTION TO EXECUTE THE INVENTION

### Description of Embodiments of the Disclosure

First, embodiments of the present disclosure will be listed and described.

(1) A shield connector according to the present disclosure includes: an inner conductor, an outer conductor that surrounds the inner conductor, and a dielectric body disposed between the inner conductor and the outer conductor, and the outer conductor includes a bottom surface, a back surface intersecting the bottom surface, a mount portion formed on the bottom surface and bonded to a surface of a circuit substrate through soldering, and a depressed portion provided in an area extending from the back surface to the bottom surface and disposed in the bottom surface in the vicinity of the mount portion.

With the above configuration, heat conductivity resistance in an area extending from the back surface of the outer conductor to the mount portion can be reduced due to the depressed portion, and thus it is possible to melt solder for the mount portion, and prevent the mount portion from entering an unsoldered state.

(2) Preferably, a plurality of the inner conductors are provided, the outer conductor includes a back portion that includes the back surface, and a partition portion that is continuous to the back portion, and the partition portion is disposed between the inner conductors adjacent to each other, and has the depressed portion defined therein.

With the above configuration, a portion that includes the depressed portion can be uniformly formed with a fixed thickness or an almost fixed thickness, in the partition portion, and thus it is possible to more effectively reduce the heat conductivity resistance in an area extending from the back surface of the outer conductor to the mount portion. In particular, crosstalk between the adjacent inner conductors is suppressed by the partition portion, and the depressed portion is formed within the thickness of the partition portion, thus realizing excellent space utilization.

(3) Favorably, the mount portion may be disposed so as to be visually recognizable through the depressed portion, in rear view of the outer conductor.

With the above configuration, it is possible to confirm, through depressed portion, a state where the mount portion and the circuit substrate are bonded to each other through soldering.

### Detailed Embodiments of Present Disclosure

Specific examples of the present disclosure will be described below with reference to the drawings. Note that the present invention is not limited to these examples, but rather is indicated by the claims, and is intended to include all modifications that are within the meanings and the scope that are equivalent to those of the claims.

### First Embodiment

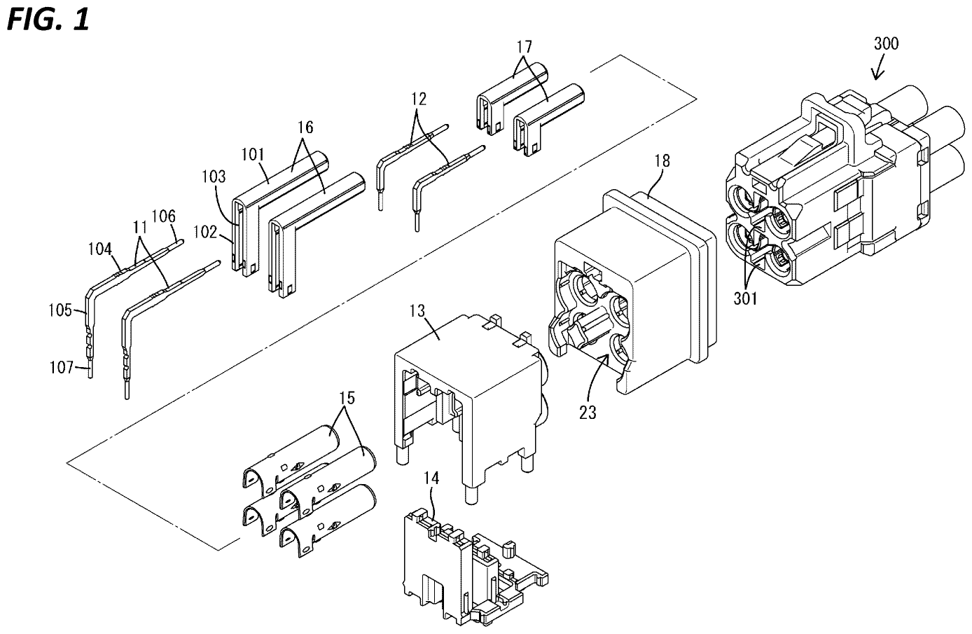

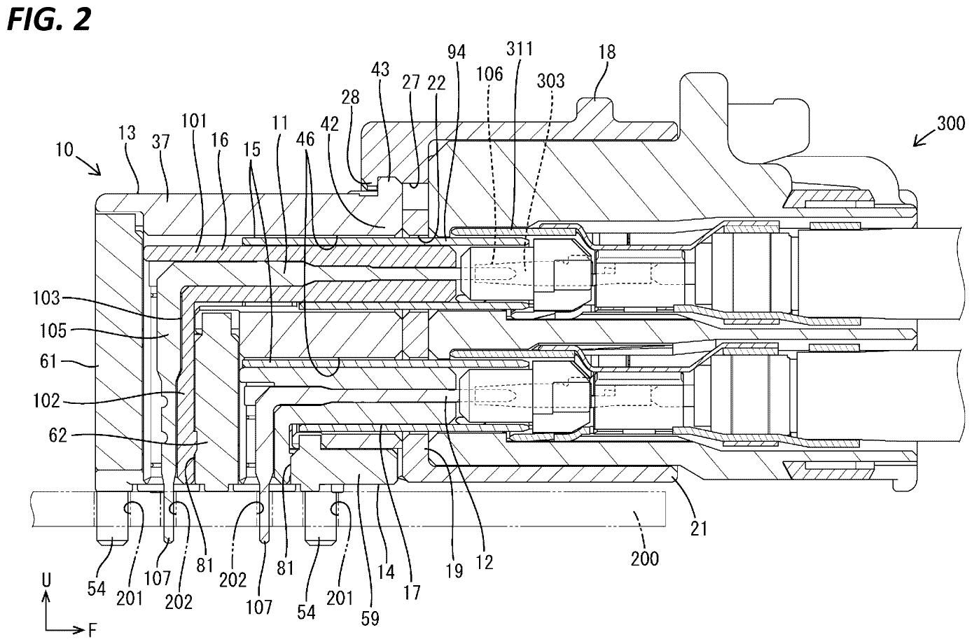

A shield connector 10 according to a first embodiment is a substrate shield connector that is installed on a circuit substrate 200. As shown in FIGS. 1 and 2, the shield connector 10 includes inner conductors 11 and 12, outer conductors 13, 14, and 15 that surround the inner conductors 11 and 12, dielectric bodies 16 respectively disposed between the inner conductors 11 and the outer conductors 13, 14, and 15 and dielectric bodies 17 respectively disposed between the inner conductors 12 and the outer conductors 13, 14, and 15, and a housing 18 to which the outer conductors 13, 14, and 15 are coupled.

The outer conductors 13, 14, and 15 and the inner conductors 11 and 12 are conductive members made of metal or the like. The dielectric bodies 16 and 17 and the housing 18 are insulative members made of a synthetic resin or the like. The housing 18 is fitted with a partner connector 300. Note that, in the following description, in the front-rear direction, a side on which the housing 18 opposes the partner connector 300 when the housing 18 is fitted with the partner connector 300 is defined as a front side. In the up-down direction, a side on which the shield connector 10 is installed on the circuit substrate 200 is defined as an upper side. The upper side in FIGS. 1 and 2 is the upper side (in the following description). In FIG. 2, the upper side is denoted by reference sign “U”, and the front side is denoted by reference sign “F”. In addition, in the following description, the up-down direction is synonymous with the height direction, and the front-rear direction is synonymous with the axial direction. In addition, the left-right direction is a direction intersecting the front-rear direction and the up-down direction, and is synonymous with the width direction. The basis of these directions is for the purpose of convenience, and does not necessarily match the basis of directions in a state where the shield connector 10 is mounted in a vehicle that is not illustrated or the like.

### Housing

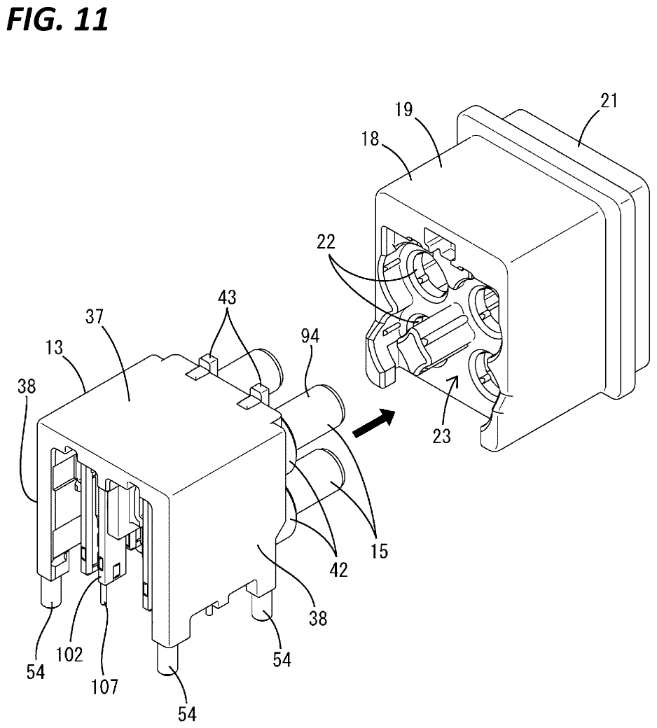

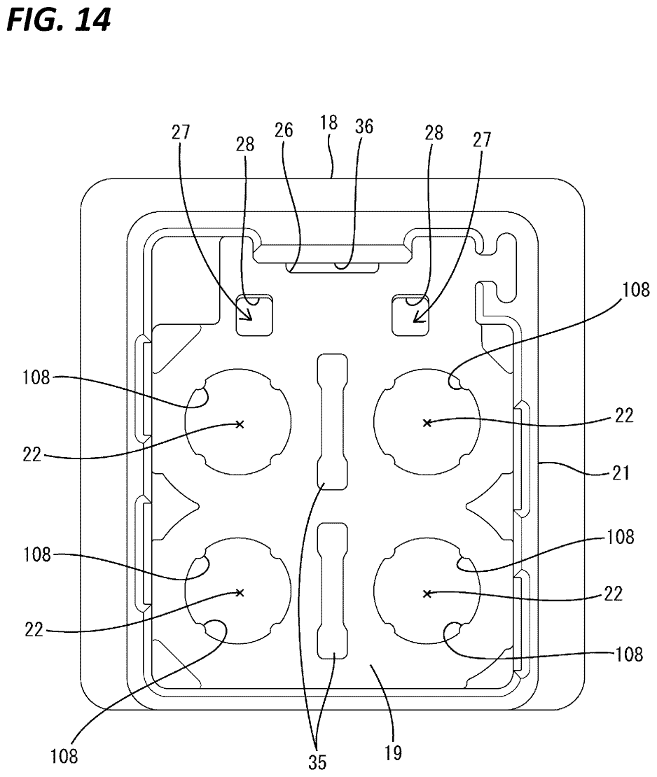

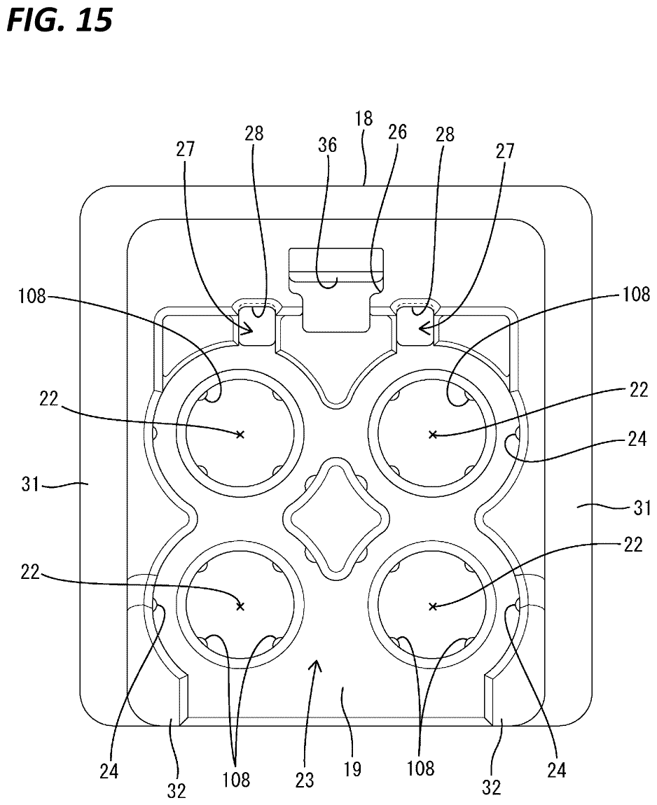

As shown in FIG. 11, the housing 18 has a rectangular outer shape overall, and includes a housing body 19 and a hood 21 that projects forward from the housing body 19. As shown in FIGS. 14 and 15, the housing body 19 includes a plurality of (in the first embodiment, four) insertion holes 22 that pass therethrough in the front-rear direction. The insertion holes 22 each have a circular cross-section, and pairs of upper and lower insertion holes 22 are aligned in the width direction.

As shown in FIG. 15, a recessed fitting portion 23 having a shape in which a portion other than a central portion of the housing body 19 is recessed is formed in the rear surface of the housing body 19. A plurality of in-recess ribs 24 are formed on the inner peripheral surface of the recessed fitting portion 23.

The housing body 19 includes a plurality of housing-side holding protrusion portions 108, on the inner peripheral surface of each of the insertion holes 22. The housing-side holding protrusion portions 108 each have an arc-shaped cross-section, and are formed to extend along the entire length of the insertion hole 22. The housing-side holding protrusion portions 108 protrude from the inner peripheral surface of the insertion hole 22, at four locations, namely at upper right, lower right, upper left, and lower left locations at equally spaced intervals in the circumferential direction as viewed from the axial direction.

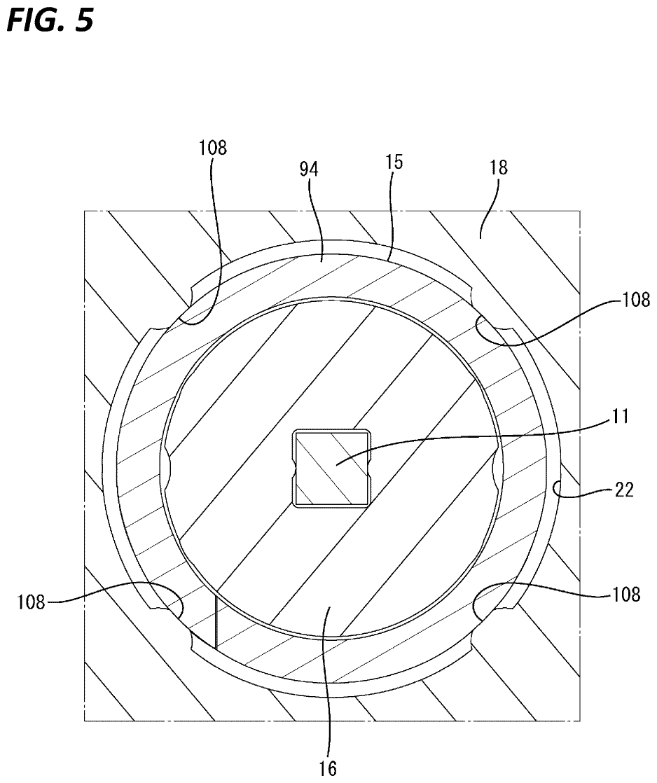

As shown in FIG. 2, the front end portions of the outer conductor tubes 15 to be described later are inserted into the insertion holes 22 of the housing body 19. As shown in FIG. 5, the housing-side holding protrusion portions 108 come into contact with the outer peripheral surface of each outer conductor tube 15.

As shown in FIG. 15, a punched recess portion 26 is formed in an upper end portion of the housing body 19. The punched recess portion 26 is formed to be opened rearward by pulling away a metal mold (not illustrated) for forming a housing locking portion 36 to be described later. In addition, a pair of fitting holes 27 are formed in upper end portions of the housing body 19, respectively on the right and left of the punched recess portion 26. As shown in FIG. 2, the fitting holes 27 pass through the upper end portions of the housing body 19 in the front-rear direction, and are in communication with the inside of the hood 21.

As shown in FIG. 15, at the rear end of the housing body 19, a pair of first locking protrusions 28 that project from the respective fitting holes 27 are formed. The first locking protrusions 28 face the rear surface of the housing body 19, and protrude to the recessed fitting portion 23 side. As shown in FIG. 2, first coupling protrusion portions 43 of the outer shell body 13 to be described later come into contact with and are locked on the front surfaces of the first locking protrusions 28.

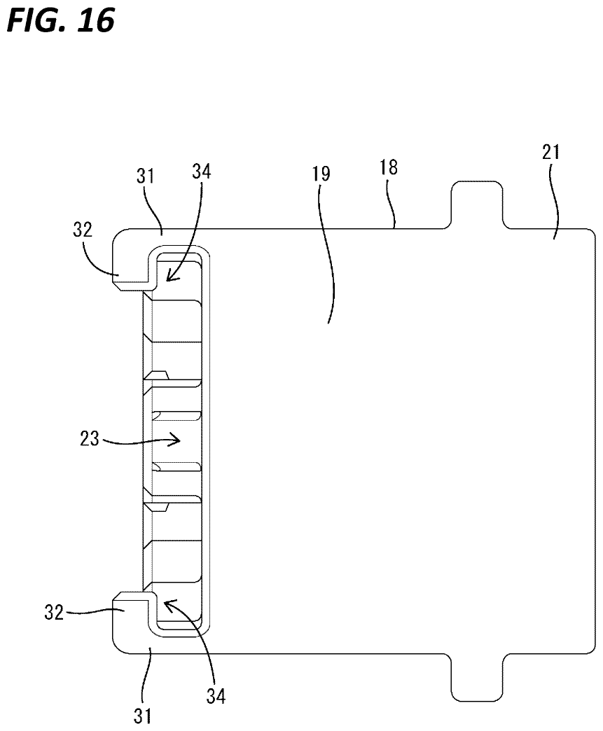

As shown in FIGS. 15 and 16, the housing body 19 includes a pair of housing side portions 31 that separate right and left sides of the recessed fitting portion 23. On the inner surfaces (surfaces opposing each other) on the lower end side of the housing side portions 31, a pair of second locking protrusions 32 are respectively formed to project to the recessed fitting portion 23 side.

As shown in FIG. 16, a pair of fitting grooves 34 are formed between the farther surface of the recessed fitting portion 23 and the second locking protrusions 32. The fitting grooves 34 are opened to the inner side in the up-down direction and the width direction (center side in the width direction of the housing 18), between the farther surface of the recessed fitting portion 23 and the second locking protrusions 32.

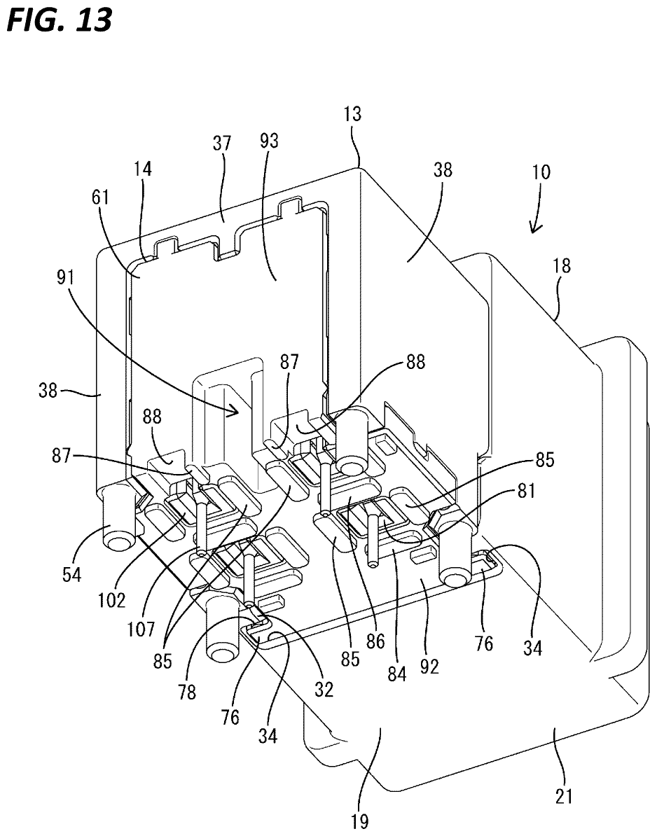

As shown in FIG. 13, second coupling protrusion portions 76 of a substrate-side outer shell body 14 to be described later are inserted into the fitting grooves 34 of the housing body 19 from below. The second coupling protrusion portions 76 of the substrate-side outer shell body 14 to be described later come into contact with the front surfaces of the second locking protrusions 32 in a pressed state.

The hood 21 is formed in a rectangular tube shape. As shown in FIG. 2, the partner connector 300 is inserted and fitted into the hood 21. As shown in FIG. 14, a pair of protrusion piece portions 35 protruding forward from the front surface of the housing body 19 are formed on the hood 21. The protrusion piece portions 35 are respectively inserted into space portions 301 (see FIG. 1) formed in the partner connector 300. The housing locking portion 36 for locking the partner connector 300 is formed on the upper wall of the hood 21. By the housing locking portion 36 locking the partner connector 300, the housing 18 and the partner connector 300 are held in a fitted state.

### Outer Conductors

As shown in FIG. 2, the outer conductors include the outer shell body 13, the substrate-side outer shell body 14, and a plurality of the outer conductor tubes 15. The outer shell body 13 and the substrate-side outer shell body 14 are conductive rigid bodies manufactured through die-casting, which originate from molding, of a zinc alloy, an aluminum alloy, or the like, and is formed by the same material. The outer shell body 13 and the substrate-side outer shell body 14 are attached to each other, and form one case. The outer conductor tubes 15 are press-molded bodies each obtained by bending a metal plate made of a material harder than the outer shell body 13 and the substrate-side outer shell body 14, such as yellow brass.

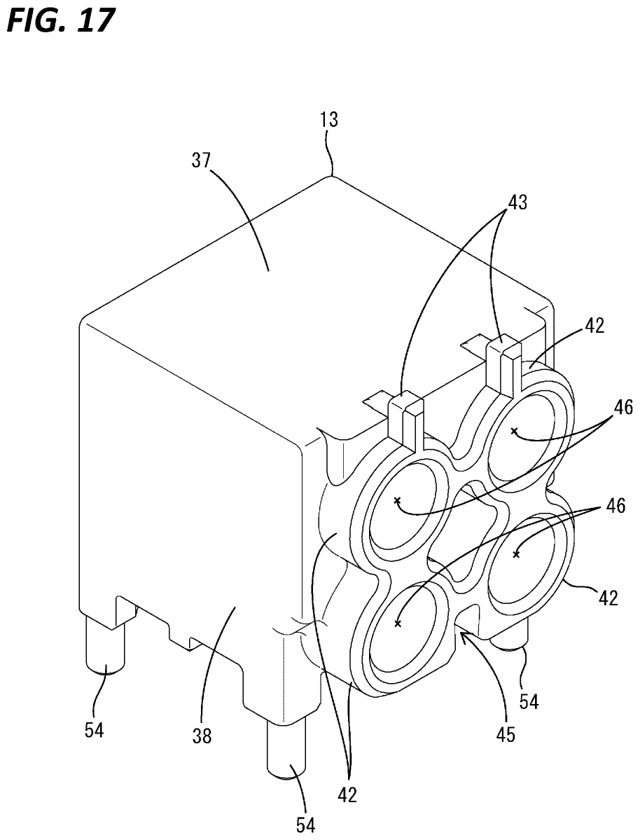

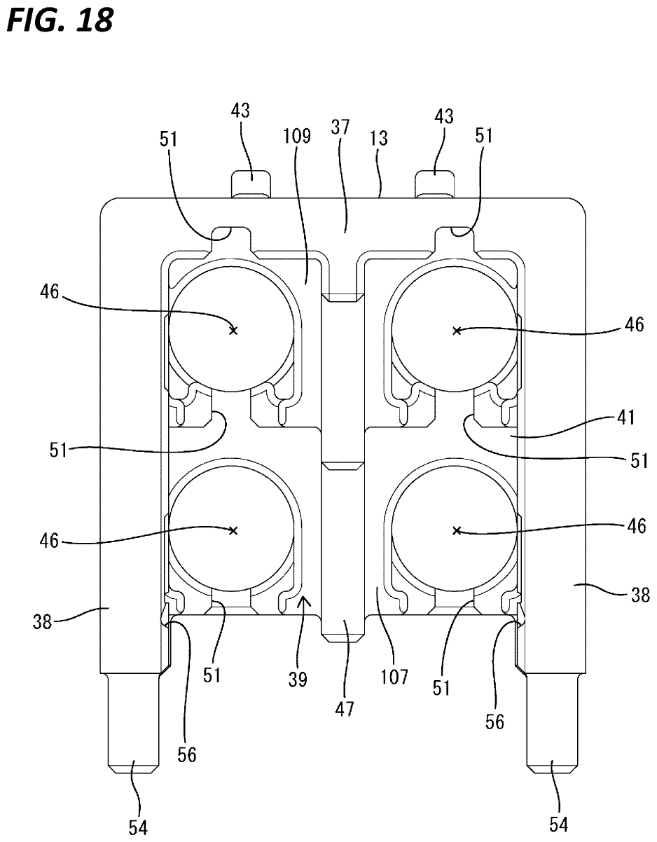

As shown in FIGS. 17 and 18, the outer shell body 13 includes an upper portion 37 that is rectangular in planar view, and a pair of side portions 38 that protrude downward from the right and left ends of the upper portion 37. A fitting receiving portion 39 is formed between the upper portion 37 and the side portions 38. The fitting receiving portion 39 is open downward and rearward, in the outer shell body 13.

In addition, as shown in FIG. 18, the outer shell body 13 has a mount portion 41 that is continuous to the upper portion 37 and the side portions 38 and have a shape that is thick on the fitting receiving portion 39 side. The mount portion 41 closes the front surface of the outer shell body 13. As shown in FIG. 17, on the front surface of the outer shell body 13, a plurality of tubular portions 42 are formed to protrude. Pairs of upper and lower tubular portions 42 are aligned in the width direction, on the front surface side of the outer shell body 13. The tubular portions 42 are coupled to each other in the up-down direction and the right-left direction, and form a shape fittable to the recessed fitting portion 23.

The outer shell body 13 includes a pair of first coupling protrusion portions 43 that protrude upward from the upper tubular portions 42. The upper ends of the first coupling protrusion portions 43 protrude above the upper portion 37.

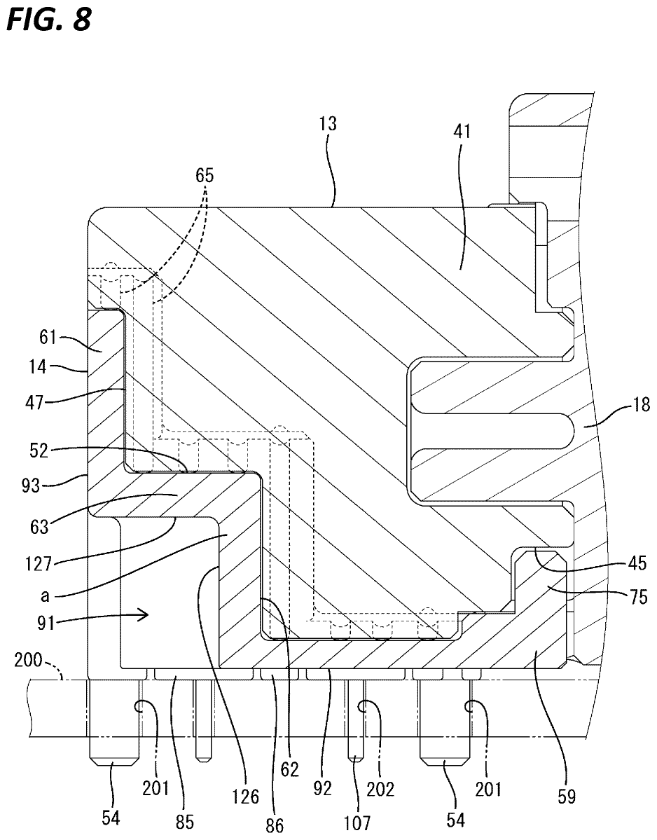

A recessed press-fitting portion 45 is formed in a lower end portion of the front surface of the outer shell body 13. The recessed press-fitting portion 45 is disposed between the lower tubular portions 42. Specifically, the recessed press-fitting portion 45 is defined by the lower tubular portions 42 and a connection portion that connects the lower tubular portions 42 to each other in the width direction, and is open forward and downward. The rear side of the recessed press-fitting portion 45 is closed by the front surface of the outer shell body 13. The recessed press-fitting portion 45 is shaped as a croze whose width gradually increases toward the upper end on the farther side from the lower end on the opening side. A later-described press-fitting protrusion portion 75 of the substrate-side outer shell body 14 is press-fitted into the recessed press-fitting portion 45 (see FIG. 8).

As shown in FIG. 18, the mount portion 41 includes a plurality of through holes 46 that pass therethrough in the front-rear direction. The through holes 46 each have a circular cross-section, and, as shown in FIG. 17, front end portions of the through holes 46 are formed on the inner side of the tubular portions 42. In a state where the outer shell body 13 and the housing 18 are coupled to each other, the tubular portions 42 are fitted into the recessed fitting portion 23 of the housing 18, and, as shown in FIG. 2, the through holes 46 of the mount portion 41 and the insertion holes 22 of the housing body 19 are respectively in communication with each other in the front-rear direction.

As shown in FIG. 18, an engaging protrusion portion 47 that protrudes to the fitting receiving portion 39 side is formed at a central portion in the width direction of the outer shell body 13. The engaging protrusion portion 47 is shaped as a plate extending along the up-down direction, in the mount portion 41, and is disposed between the through holes 46 adjacent in the width direction. The lower end of the engaging protrusion portion 47 has a step-like shape (see FIG. 8). The upper through holes 46 in the mount portion 41 are formed to extend rearward further than the lower through holes 46 so as to follow the step-like shape of the lower end of the engaging protrusion portion 47 (see FIG. 2).

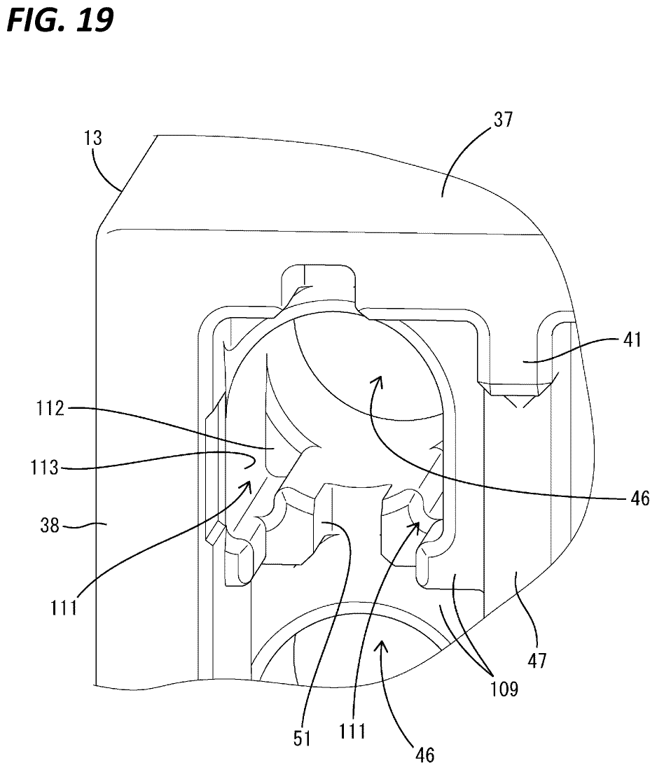

As shown in FIG. 18, the through holes 46 are open in end surfaces 109 facing rearward in the fitting receiving portion 39. As shown in FIG. 19, the end surfaces 109 in which the upper through holes 46 are open are positioned on the rear side relative to the end surfaces 109 in which the lower through holes 46 are open.

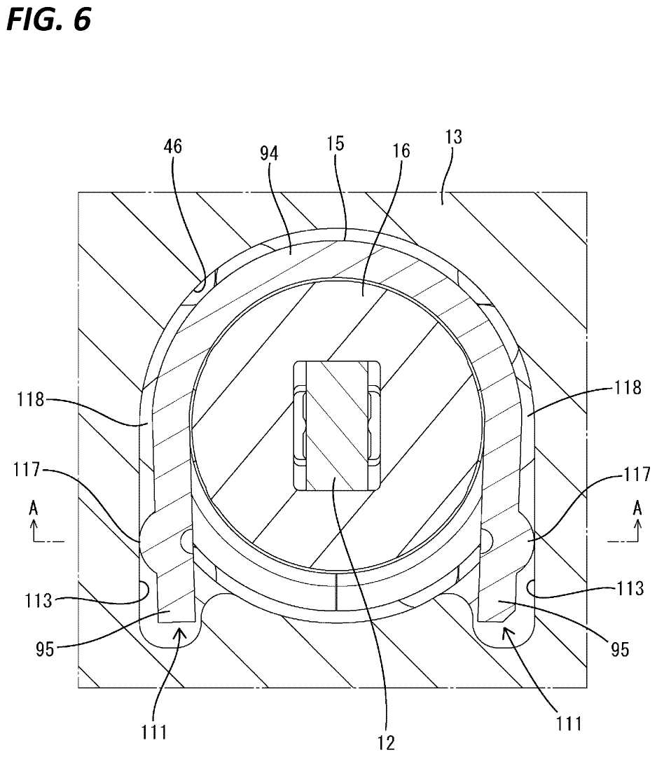

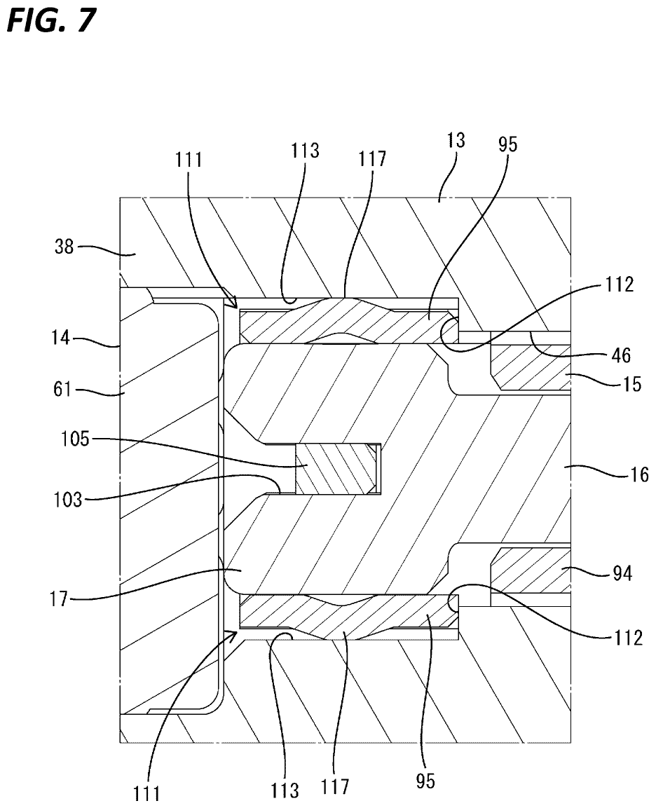

As shown in FIG. 19, a pair of cut grooves 111 having a shape cut forward from the right and left side edges on the lower side of the opening edge on the rear side of each through hole 46 are formed in the end surface 109 of the mount portion 41. A groove portion 51 to be described later is disposed between the cut grooves 111. The outer shell body 13 includes stopper portions 112 that close the front ends of the cut grooves 111, in the through hole 46. The stopper portions 112 are front surfaces of the cut grooves 111, and are disposed along the up-down direction similarly to the end surface 109. In addition, the outer shell body 13 includes restriction portions 113 that close the outer side in the width direction of the cut grooves 111, in the through hole 46. The restriction portions 113 are portions of the inner surfaces of the side portions 38, and are disposed along the front-rear direction, and the front ends of the restriction portions 113 intersects the stopper portions 112. The stopper portions 112 can abut on and stop projection portions 95 of the outer conductor tube 15 to be described later (see FIG. 7), and the restriction portions 113 can restrict rotation of the outer conductor tube 15 in the through hole 46 (see FIG. 6).

As shown in FIG. 18, a plurality of groove portions 51 are formed in the outer shell body 13. The groove portions 51 are formed by notching lower portions of peripheral walls of the mount portion 41 that surround the through holes 46 (including portions having a step-like shape), and the groove portions 51 are disposed in the inner surface of a rear end portion of the upper portion 37 in a recessed manner. The groove portions 51 are disposed for the through holes 46, and are opened downward and rearward, namely on the fitting receiving portion 39 side. The groove portions 51 in the lower portions of the peripheral walls are open in the end surface 109.

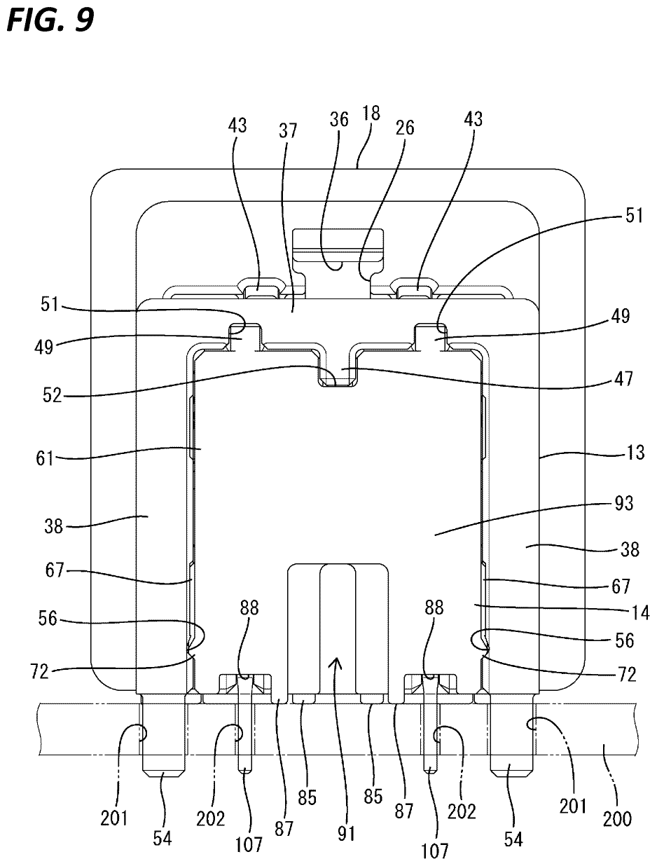

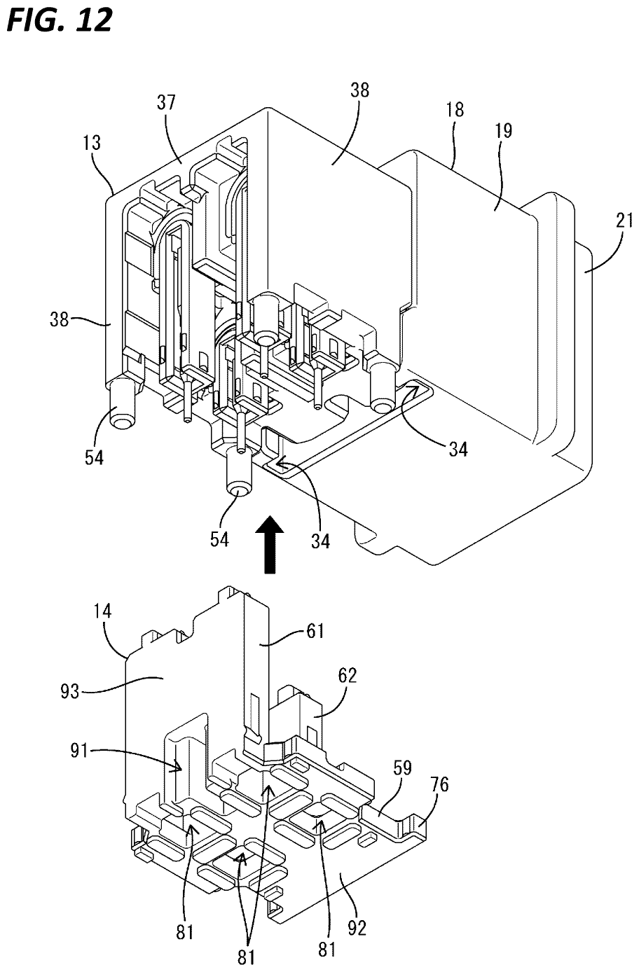

As shown in FIGS. 12 and 13, in front and rear end portions of the lower ends of the side portions 38, four leg portions 54 are respectively formed to protrude downward. The leg portions 54 are arranged in correspondence with four lower end corner portions of the outer shell body 13. As shown in FIGS. 2 and 9, the leg portions 54 are positioned at and inserted into fixed holes 201 of the circuit substrate 200.

As shown in FIG. 18, a pair of recessed portions 56 are formed in rear-side lower end portions of the inner surfaces of the side portions 38 (which are also the inner surface of the fitting receiving portion 39). The recessed portions 56 are opened inward in the width direction (on the side on which the side portions 38 oppose each other) and rearward. As shown in FIG. 9, later-described protrusion portions 72 of the substrate-side outer shell body 14 are fitted into the recessed portions 56.

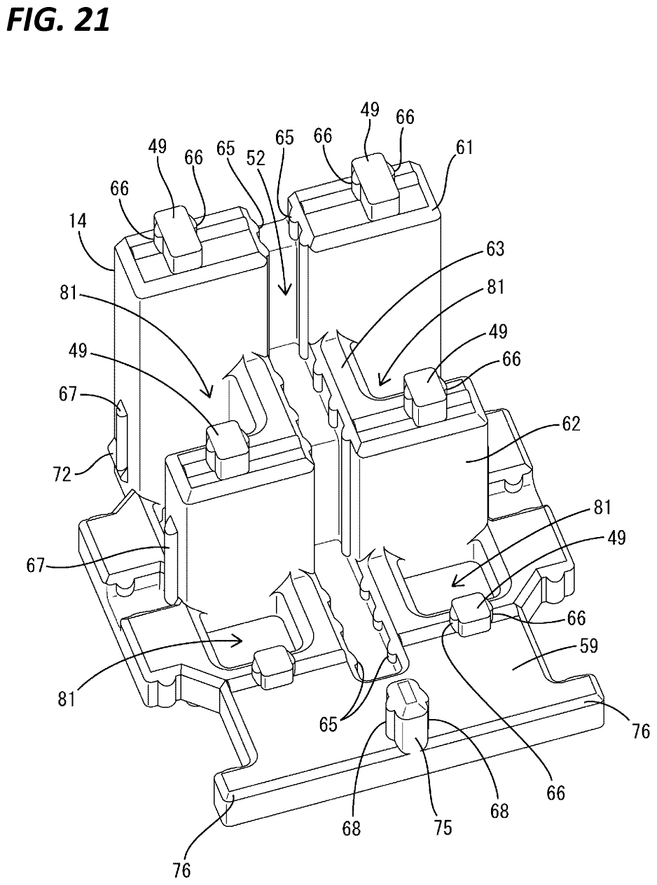

As shown in FIGS. 12 and 13, the substrate-side outer shell body 14 is attached to the outer shell body 13 from below. As shown in FIG. 21, the substrate-side outer shell body 14 includes a bottom portion 59 that is rectangular as viewed from the bottom surface, a back portion 61 standing upright from a rear end portion of the bottom portion 59, a standing portion 62 standing upright from a position close to a rear end portion of the bottom portion 59, and a partition portion 63 that connects the back portion 61 and the standing portion 62, in a central portion in the width direction of the bottom portion 59. The back portion 61, the standing portion 62, and the partition portion 63 are configured as fitting portions that can be fitted into the fitting receiving portion 39 of the outer shell body 13.

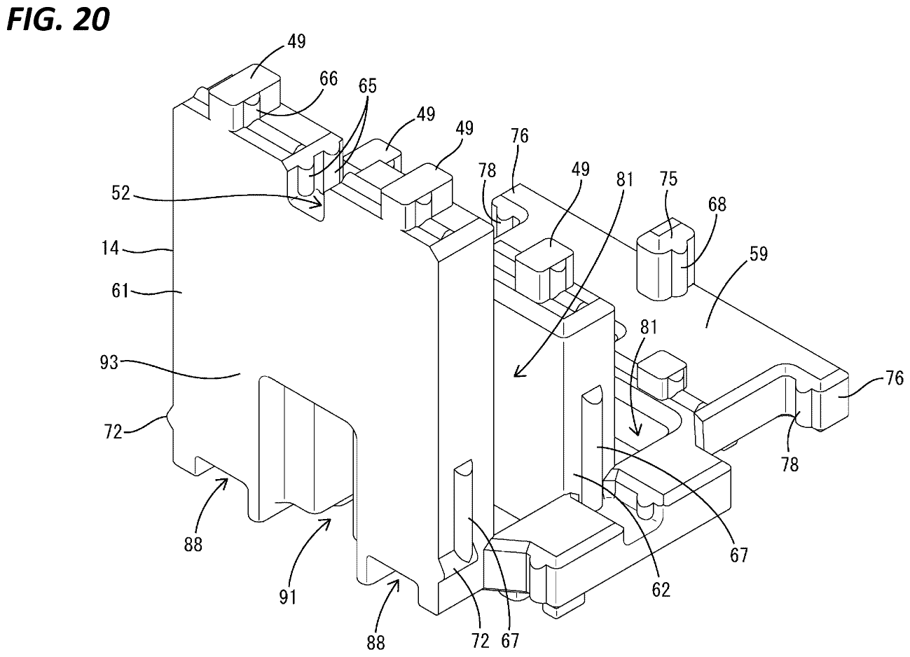

The back portion 61 and the standing portion 62 are each shaped as a vertical wall that is rectangular in rear view. As shown in FIG. 9, the back portion 61 closes the rear surface of the outer shell body 13. As shown in FIGS. 20 and 21, the protruding length of the standing portion 62 is set smaller than the protruding length of the back portion 61. The difference in height between the upper end surface of the standing portion 62 and the upper end surface of the back portion 61 corresponds to the difference in height of the step-like shape of the mount portion 41. The upper end surface of the standing portion 62 and the upper end surface of the partition portion 63 have the same height, and are continuous to each other.

As shown in FIG. 21, a groove portion 52 is formed in a central portion in the width direction of the substrate-side outer shell body 14. The groove portion 52 is provided in the upper surfaces and the front surfaces of the back portion 61, the partition portion 63, the standing portion 62, and the bottom portion 59 in a continuous manner, forming a step-like shape.

A plurality of contact ribs 65 extending in the up-down direction are provided on the two side surfaces of the groove portion 52 that oppose each other in the width direction. The contact ribs 65 have an arc-shaped cross-section. A large number of contact ribs 65 are formed on the side surfaces of the groove portion 52 that correspond to the back portion 61, the partition portion 63, the standing portion 62, and the bottom portion 59, at intervals in the front-rear direction.

A pair of engaging protrusion portions 49 are formed on sections on the right and left sides of the upper surface of each of the back portion 61, the standing portion 62, and the bottom portion 59, with the groove portion 52 interposed therebetween. Also, on the two side surfaces of each of the engaging protrusion portions 49, the contact ribs 66 extending in the up-down direction are formed.

In a state where the outer shell body 13 and the substrate-side outer shell body 14 are attached to each other, a lower end portion of the engaging protrusion portion 47 of the outer shell body 13 is fitted into the groove portion 52 of the substrate-side outer shell body 14 (see FIG. 8). In addition, the engaging protrusion portions 49 of the substrate-side outer shell body 14 are fitted into the groove portions 51 of the outer shell body 13, a portion of which is shown in FIG. 9. The contact ribs 65 and 66 of the substrate-side outer shell body 14 come into contact with the outer surface of the engaging protrusion portion 47 and the inner surfaces of the groove portions 51 of the outer shell body 13. Furthermore, as shown in FIGS. 20 and 21, contact ribs 67 elongated in the up-down direction are also formed on the two side surfaces of the back portion 61 and the two side surfaces of the standing portion 62. The contact ribs 67 come into contact with the inner surfaces of the side portions 38 of the outer shell body 13 (see FIG. 9).

As shown in FIG. 20, the substrate-side outer shell body 14 includes a pair of protrusion portions 72, at lower-side rear end portions of the two side surfaces thereof. The protrusion portions 72 have a shape with an arc-shaped cross-section, extending in the front-rear direction on the two side surfaces of the bottom portion 59. The front end sides of the protrusion portions 72 are integrally continuous to the lower ends of the contact ribs 67 formed on the two side surfaces of the back portion 61. In a state where the outer shell body 13 and the substrate-side outer shell body 14 are attached to each other, as shown in FIG. 9, the protrusion portions 72 are fitted into lower side portions of the recessed portions 56, and the lower surfaces of the protrusion portions 72 come into contact with the lower surfaces of the recessed portions 56 in a compressed or crushed state.

As shown in FIGS. 20 and 21, in a central portion in the width direction of the upper surface of the front end portion of the bottom portion 59, the press-fitting protrusion portion 75 is formed to protrude. The press-fitting protrusion portion 75 has a columnar shape, and is formed with a uniform cross-sectional shape in the up-down direction, except for an upper end portion. Also, on the two side surfaces of the press-fitting protrusion portion 75, a pair of contact ribs 68 extending in the up-down direction are formed. The contact ribs 68 come into contact with the inner surface of the recessed press-fitting portion 45.

As shown in FIG. 20, the substrate-side outer shell body 14 includes a pair of second coupling protrusion portions 76 that protrude outward in the width direction from the front end of the two side surfaces of the bottom portion 59. Pressing ribs 78 having an arc-shaped cross-section and extending in the up-down direction are respectively formed on the rear surfaces of the second coupling protrusion portions 76. In a state where the second coupling protrusion portions 76 are fitted into the fitting grooves 34 of the housing 18, the pressing ribs 78 of the second coupling protrusion portions 76 come into contact with the front surfaces of the second locking protrusions 32 in a pressing state (see FIG. 13).

As shown in FIG. 21, a plurality of opening portions 81 are formed in the substrate-side outer shell body 14. The opening portions 81 have a rectangular cross-section, and are disposed on right and left sides of the substrate-side outer shell body 14 with the groove portion 52 interposed therebetween, at front and rear positions. The opening portions 81 on the front side are positioned in front of the standing portion 62 and behind the engaging protrusion portions 49 formed on the bottom portion 59, pass through the bottom portion 59, and are open to a bottom surface 92 (surface that faces downward, see FIG. 12). The opening portions 81 on the rear side are defined by the back portion 61, the standing portion 62, and the partition portion 63, pass through the bottom portion 59 in the same manner, and are open to the bottom surface 92. The partition portion 63 separates the opening portions 81 on the rear side adjacent in the width direction.

As shown in FIG. 2, the dielectric bodies 16 and 17 are fitted into the opening portions 81. The inner conductors 11 and 12 respectively mounted to the dielectric bodies 16 and 17 cause substrate connection portions 107 to be described later to protrude downward from the bottom surface 92 of the bottom portion 59 through the opening portions 81. The substrate connection portions 107 are inserted into connection holes 202 formed in the circuit substrate 200, and are electrically connected to conductive portions (not illustrated).

As shown in FIG. 13, on the bottom surface 92 of the bottom portion 59, a plurality of mount portions 84 to 87 are formed so as to surround each opening portion 81. The mount portions 84 to 87 slightly protrude downward from the bottom surface 92 of the bottom portion 59. The lower end surfaces of the mount portions 84 to 87 have flat shapes, and are electrically connected to conductive portions for the ground of the circuit substrate 200 through soldering.

Specifically, the mount portions include front mount portions 84 extending in the left-right direction in front of the front opening portions 81, lateral mount portions 85 extending in the front-rear direction on the right and left of each of the opening portions 81, and shared mount portions 86 extending in the left-right direction between the front opening portions 81 and the rear opening portions 81. In addition, complementary mount portions 87, which are mount portions, are also formed on the right and left of a depressed portion 91 to be described later.

Recessed regression portions 88 are provided in a rear end portion of the bottom surface 92 of the bottom portion 59. The rear ends of the recessed regression portions 88 are open to a back surface 93 intersecting the bottom surface 92, on the substrate-side outer shell body 14. The recessed regression portions 88 have a rectangular cross-section, and are in communication with the opening portions 81 in front thereof, and are opened rearward and downward, and, on the other hand, the upper sides of the recessed regression portions 88 are closed by the back portion 61.

The recessed regression portions 88 are disposed above surface layer wiring (not illustrated) of the circuit substrate 200. Electrical connection between the substrate-side outer shell body 14 and the surface layer wiring is avoided due to the recessed regression portions 88.

The complementary mount portions 87 correspond to the recessed regression portions 88, and are formed to extend in the front-rear direction along the inner side edges positioned on the central side in the width direction of the bottom portion 59, from among the two side edges of the recessed regression portions 88.

As shown in FIG. 13, the depressed portion 91 is provided in a central portion in the width direction of the back surface 93 of the substrate-side outer shell body 14. As shown in FIG. 9, the depressed portion 91 is formed to extend in the up-down direction from the bottom portion 59 to the back portion 61 of the back surface 93 of the substrate-side outer shell body 14. The depressed portion 91 is provided to cover the bottom surface 92 and the back surface 93 of the substrate-side outer shell body 14, and is open rearward and downward.

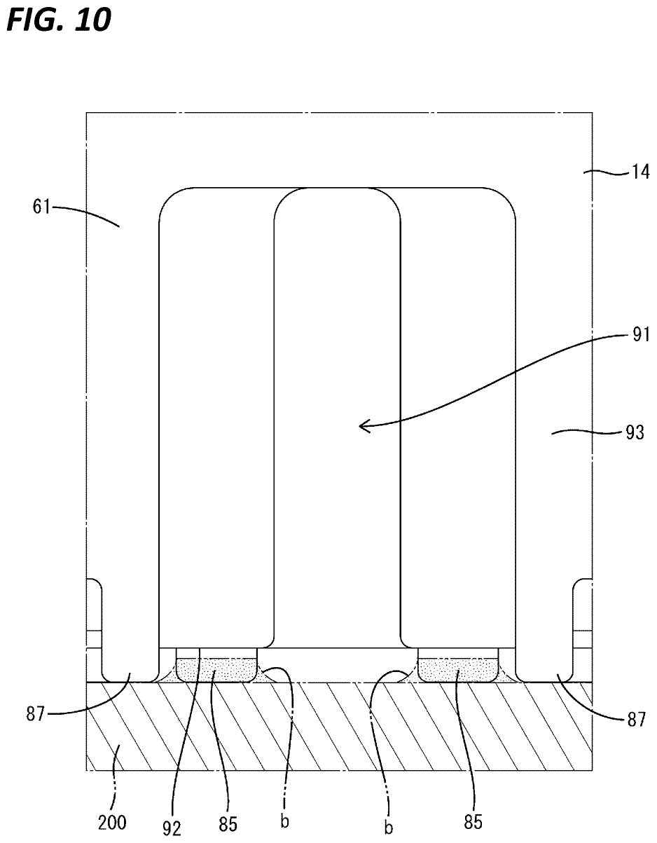

The depressed portion 91 passes through the back portion 61, and is defined inside the partition portion 63. That is to say, the depressed portion 91 is formed within the thickness range of the partition portion 63. As shown in FIG. 8, an inner and farther surface 126 and an inner and upper surface 127 of the depressed portion 91 are disposed in parallel with, and respectively behind and below the groove portion 52, opposing the groove portion 52 in a back-to-back manner. A portion of the partition portion 63 that is between the depressed portion 91 and the groove portion 52 (see reference sign “a” in FIG. 8) is formed with a uniform thickness or an almost uniform thickness from the back portion 61 to the bottom portion 59. The thickness of a section of the partition portion 63 that corresponds to the depressed portion 91 is reduced. As shown in FIG. 13, the complementary mount portions 87 are disposed between the depressed portion 91 and the recessed regression portions 88 in the width direction, on the bottom surface 92 of the bottom portion 59. As shown in FIGS. 9 and 10, the lateral mount portions 85 positioned on the inner side in the width direction of the bottom surface 92 of the substrate-side outer shell body 14 (on the center side in the width direction) from among the lateral mount portions 85 are disposed so as to be visually recognizable through the depressed portion 91, in rear view of the substrate-side outer shell body 14.

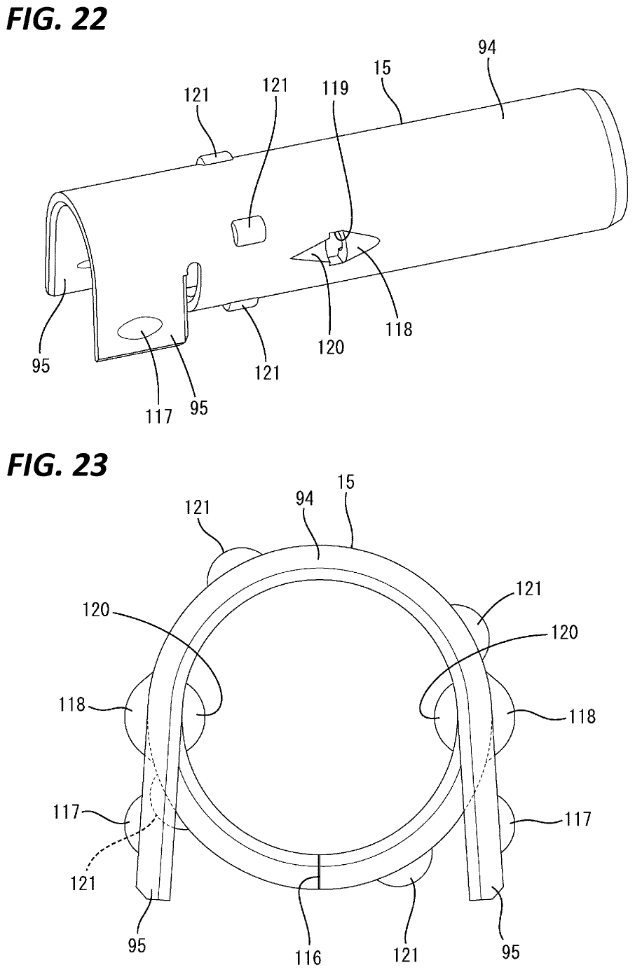

Each outer conductor tube 15 is integrally formed by, for example, bending a conductive metal plate, and is formed to be thinner than the outer shell body 13 and the substrate-side outer shell body 14. As shown in FIG. 22, the outer conductor tube 15 includes a tubular connection portion 94 formed in a cylindrical shape and extending in the front-rear direction and a pair of projection portions 95 protruding downward from the right and left sides of a rear end portion of the tubular connection portion 94. The tubular connection portion 94 is formed by bending a plate material into a circular shape, and includes, at a lower end thereof, a butt edge 116 in which two ends in the circumferential direction butt against each other, as shown in FIG. 23.

The projection portions 95 has a tapered shape extending downward from the right and left ends of the upper half of a rear end portion of the tubular connection portion 94, in a state before the outer conductor tube 15 is inserted into a through hole 46 of the outer shell body 13. In addition, the projection portions 95 are formed in a rectangular shape in side view. Embossed contact protrusion portions 117 bulging outward are formed at sections close to the lower ends of the projection portions 95. The contact protrusion portions 117 have an arc-shaped cross-section.

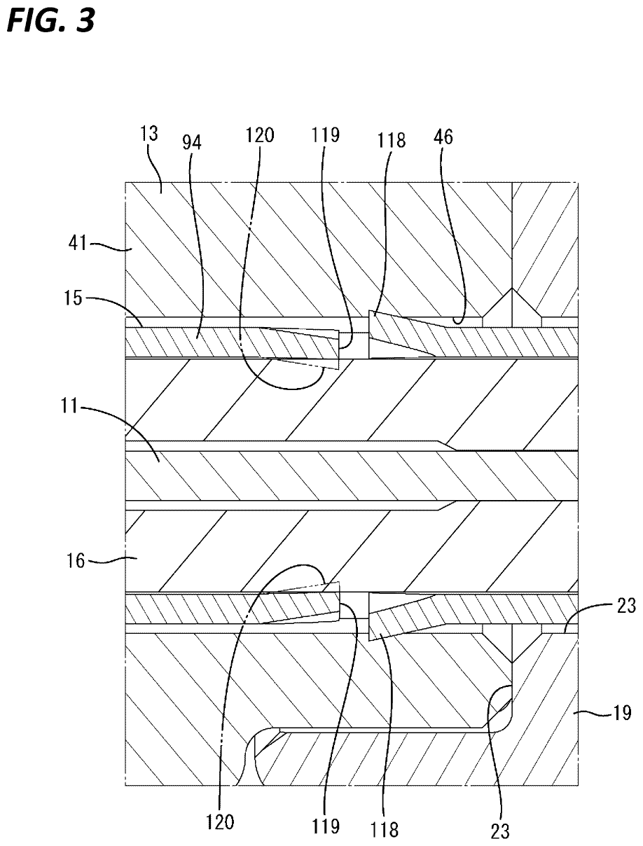

In addition, press-fitting blades 118 are formed at intermediate portions in the front-rear direction of the tubular connection portion 94. A pair of press-fitting blades 118 are disposed at the right and left ends of the tubular connection portion 94 (the two ends in the radial direction), and are formed in a shape bulging outward, in front of a slit 119 extending along the up-down direction (which is also the circumferential direction of the tubular connection portion 94). Specifically, as shown in FIG. 22, the press-fitting blades 118 have an arc-shaped cross-section, and are each formed in a triangular shape whose length in the up-down direction decreases forward in side view. As shown in FIG. 3, the press-fitting blades 118 are pressure-fitted into and locked on the inner peripheral surface of a through hole 46 of the outer shell body 13.

In addition, inner-side protrusions 120 are formed in an intermediate portion in the front-rear direction of the tubular connection portion 94. As shown in FIG. 23, a pair of inner-side protrusions 120 are disposed at the right and left ends of the tubular connection portion 94, and are formed in a shape bulging inward, on the rear side of the slits 119 extending along the up-down direction (which is also the circumferential direction of the tubular connection portion 94). The inner-side protrusions 120 are locked on the outer surface of a dielectric body 16 or 17 disposed in the tubular connection portion 94 (see FIG. 3).

As shown in FIG. 22, a plurality of holding protrusion portions 121 are formed at sections of the tubular connection portion 94 that are on the rear side relative to the press-fitting blades 118 and on the front side relative to the projection portions 95. The holding protrusion portions 121 are formed in an embossed shape bulging outward from the tubular connection portion 94, and are formed to extend in the front-rear direction with a uniform (arc-shaped) cross-sectional shape.

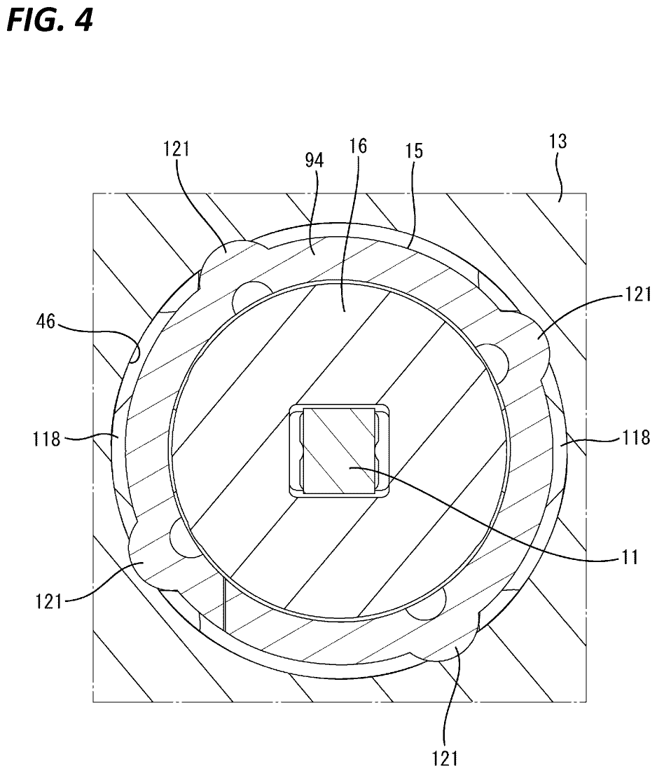

In addition, as shown in FIG. 23, four holding protrusion portions 121 are provided at a certain interval in the circumferential direction, on the outer peripheral surface of the tubular connection portion 94. The protruding length of the press-fitting blades 118 from the outer peripheral surface of the tubular connection portion 94 is larger than that of the holding protrusion portions 121. When the tubular connection portion 94 is viewed from the axial direction (the front side or the rear side in the depth direction of FIG. 23), the holding protrusions portions 121 are displaced from the press-fitting blades 118 in the circumferential direction. Specifically, the holding protrusion portions 121 are disposed at four locations, namely upper right, lower right, upper left, lower left locations, based on upper, lower, right and left sections when the tubular connection portion 94 is viewed from the front. The lower right holding protrusion portion 121 in FIG. 23 is disposed near the butt edge 116 of the tubular connection portion 94. As shown in FIG. 4, the holding protrusion portions 121 come into contact with the inner peripheral surface of the through hole 46 of the outer shell body 13.

The outer conductor tube 15 is inserted into the through hole 46 of the outer shell body 13 from behind. A plurality of, (in the first embodiment, four) outer conductor tubes 15 are provided in correspondence with the through holes 46, and are formed in the same shape as shown in FIG. 1. The projection portions 95 of the outer conductor tube 15 abut on and are stopped by the stopper portions 112 (see FIG. 7), the press-fitting blades 118 are locked on the inner peripheral surface of the through hole 46 (see FIG. 3), and furthermore, the contact protrusion portions 117 come into contact with the restriction portions 113 in a state where the projection portions 95 elastically deform (see FIG. 6), and thereby the outer conductor tube 15 is held on the outer shell body 13 in a retained state. Front end portions of the tubular connection portions 94 of the outer conductor tubes 15 of the shield connector 10 protrude from the tubular portions 42 of the outer shell body 13 into the hood 21 (see FIG. 2).

### Dielectric Bodies

As shown in FIG. 1, each of the dielectric bodies 16 and 17 includes a cylindrical main body portion 101 extending in the front-rear direction and a drawer portion 102 protruding downward from a rear end portion of the main body portion 101, and is formed in an L-shape in side view. A later-described horizontal portion 104 of an inner conductor 11 or 12 is inserted into the main body portion 101. A guide groove 103 extending in the up-down direction is formed in the rear surface of the drawer portion 102. The guide groove 103 is open rearward. A later-described extended portion 105 of the inner conductor 11 or 12 is fitted into the guide groove 103 from behind (see FIGS. 2 and 7).

The main body portions 101 of the dielectric bodies 16 and 17 are disposed in the through holes 46 of the outer shell body 13, in a state of being inserted into the tubular connection portions 94 of the outer conductor tubes 15. The drawer portions 102 of the dielectric bodies 16 and 17 are inserted into the opening portions 81 of the substrate-side outer shell body 14.

As shown in FIG. 1, the dielectric bodies include two types of dielectric bodies, namely the long dielectric bodies 16 and the short dielectric bodies 17. As shown in FIG. 2, the long dielectric bodies 16 are held on the outer conductors 13, 14, and 15 in a state where the main body portions 101 are disposed in the upper through holes 46 and the drawer portions 102 are inserted into the rear opening portions 81. The short dielectric bodies 17 are held on the outer conductors 13, 14, and 15 in a state where the main body portions 101 are disposed in the lower through holes 46 and the drawer portions 102 are inserted into the front opening portions 81.

### Inner Conductors

As shown in FIG. 1, the inner conductors 11 and 12 are pin-like terminals, each include the horizontal portion 104 extending in the front-rear direction and the extended portion 105 extending downward from a rear end portion of the horizontal portion 104, and are formed in an L-shape in side view. The horizontal portion 104 includes a partner connection portion 106 protruding forward from the main body portion 101 in a state of being inserted into the main body portion 101 of a dielectric body 16 or 17. As shown in FIG. 2, the partner connection portion 106 protrudes into the hood 21, and is electrically connected to a partner inner conductor 303 in a state where the housing 18 and the partner connector 300 are fitted with each other. The extended portion 105 includes the substrate connection portion 107 protruding downward from the drawer portion 102 in a state of being inserted into the guide groove 103 of the drawer portion 102 of the dielectric body 16 or 17. The substrate connection portion 107 is formed with a smaller diameter than an upper portion of the extended portion 105.

As shown in FIG. 1, the inner conductors include two types of inner conductors, namely the long inner conductors 11 and the short inner conductors 12. The long inner conductors 11 are held by the long dielectric bodies 16. The short inner conductors 12 are held by the short dielectric bodies 17.

### Method for Attaching Shield Connector and Actions Thereof

First, the horizontal portions 104 of the inner conductors 11 and 12 are respectively inserted into the main body portions 101 of the corresponding dielectric bodies 16 and 17 from behind, and are held thereon. The extended portions 105 of the inner conductors 11 and 12 are exposed on the rear surface side of the drawer portions 102 in a state of being inserted into the guide grooves 103. Next, the main body portions 101 of the dielectric bodies 16 and 17 are inserted into the tubular connection portions 94 of the corresponding outer conductor tubes 15 from behind, and are held thereon. In addition, the tubular connection portions 94 of the outer conductor tubes 15 are inserted into the corresponding through holes 46 of the outer shell body 13 from behind, and are held thereon.

At the end of a process of inserting a tubular connection portion 94, the projection portions 95 enter the cut grooves 111 from behind, and the contact protrusion portions 117 of the projection portions 95 slide along the restriction portions 113. At this time, the projection portions 95 are caused to elastically transform inward in the width direction (to the center side in the width direction of the outer conductor tubes 15) using a coupling section for the tubular connection portion 94 as a support.

When the tubular connection portion 94 is properly inserted into the through hole 46 of the outer shell body 13, the front ends (plate thickness portion) of the projection portions 95 abut on the stopper portions 112 of the outer shell body 13 (see FIG. 7), and an operation of further inserting the outer conductor tube 15 is restricted. The projection portions 95 bring the contact protrusion portions 117 into firm contact with the restriction portions 113 while remaining in an elastically deformed state (see FIG. 6). The outer conductor tube 15 is attached to the outer shell body 13 in a state where shakiness is restricted, due to locking action of the projection portions 95 on the outer shell body 13 and later-described holding action of the press-fitting blades 118 and the holding protrusion portions 121.

In the first embodiment, the outer conductor tube 15 is attached to the outer shell body 13 from behind, and thus it is possible to easily form a structure in which the stopper portions 112 restrict the outer conductor tube 15 coming loose forward. In particular, a direction in which the outer conductor tubes 15 are inserted into the outer shell body 13, a direction in which the inner conductors 11 and 12 are inserted into the dielectric bodies 16 and 17, a direction in which the dielectric bodies 16 and 17 are inserted into the outer conductor tubes 15, and a direction in which the outer shell body 13 is coupled to the housing 18, as will be described later, are all the same, that is to say a direction from the rear to the front, and thus the ease of attachment excels.

In addition, in a state where the tubular connection portions 94 are properly inserted into the through holes 46 of the outer shell body 13, the press-fitting blades 118 of the outer conductor tubes 15 are locked on right and left end sections of the inner peripheral surfaces of the through holes 46 of the outer shell body 13 so as to bite thereinto (compressed or crushed state) in a press-in state (see FIG. 3). In addition, the holding protrusion portions 121 of the outer conductor tubes 15 come into firm contact with upper, lower, right, and left sections of the inner peripheral surfaces of the through holes 46 of the outer shell body 13, on the rear side relative to the locking positions of the press-fitting blades 118 (see FIG. 4).

As shown in FIG. 11, front end portions of the tubular connection portions 94 protrude forward from the tubular portions 42 of the outer shell body 13. Assuming that the holding protrusion portions 121 are not formed on the tubular connection portions 94, and external force acts on the front end portions of the tubular connection portions 94 from above or from below, there is a concern that the tubular connection portions 94 will be pressed in an external force direction, and the axial centers of the tubular connection portions 94 will be displaced. With this regard, in the first embodiment, in addition to the press-fitting blades 118, a plurality of holding protrusion portions 121 are formed on each tubular connection portion 94, and the holding protrusion portions 121 are arranged at intervals in the circumferential direction, at upper, lower, right, and left sections of the tubular connection portion 94. In addition, the holding protrusion portions 121 come into contact with the inner peripheral surfaces of the through holes 46 of the outer shell body 13, and are held thereon, and thus it is possible to resist external force from above or from below, and to prevent the axial centers of the tubular connection portions 94 from being displaced.

Subsequently, the outer shell body 13 is coupled to the housing 18 from behind (see FIG. 11). In a process of coupling the outer shell body 13, the first coupling protrusion portions 43 move beyond the first locking protrusions 28, and are fitted into the fitting holes 27. When coupling of the outer shell body 13 is completed, the tubular portions 42 come into contact with farther surface of the recessed fitting portion 23, an operation of coupling the outer shell body 13 is stopped, and the rear surfaces of the first coupling protrusion portions 43 and the front surfaces of the first locking protrusions 28 come into contact with each other (see FIG. 2).

The front end portions of the tubular connection portion 94 are inserted into the insertion holes 22 of the housing 18 from behind. In the insertion holes 22, the housing-side holding protrusion portions 108 come into contact with the outer peripheral surface of front portions of the tubular connection portions 94 in a compressed or crushed state (see FIG. 5). The housing-side holding protrusion portions 108 come into contact with the outer peripheral surfaces of the tubular connection portions 94 from the upper, lower, right, and left sides. Accordingly, the tubular connection portions 94 are held on the outer shell body 13 using the press-fitting blades 118 and the holding protrusion portions 121, and, in addition, are held on the housing 18 using the housing-side holding protrusion portions 108 positioned on the opposite side to the holding protrusion portions 121 (on the front side) with the press-fitting blades 118 therebetween. Thus, in the first embodiment, it is possible to more reliably prevent the axial centers of the tubular connection portions 94 from being displaced. As a result, it is possible to realize a state where the axial centers of the tubular connection portions 94 match the axial centers of partner outer conductors 311 (see FIG. 2).

Next, the substrate-side outer shell body 14 is attached to the outer shell body 13 from below (see FIG. 12). At the end of a process of attaching the substrate-side outer shell body 14, the protrusion portions 72 interfere with the side portions 38, and the side portions 38 elastically deform outward in the width direction using the upper portion 37 side as a support, in a greater or lesser degree. When attachment of the substrate-side outer shell body 14 is completed, the engaging protrusion portion 47 of the outer shell body 13 comes into contact with the bottom surface of the groove portion 52 of the substrate-side outer shell body 14, or the like, an operation of attaching the substrate-side outer shell body 14 is stopped, restoring force acts on the side portions 38, and the protrusion portions 72 are fitted into the recessed portions 56 (see FIG. 9). Here, a lap margin is set between the protrusion portions 72 and the recessed portions 56, and thus the protrusion portions 72 come into contact with the inner surfaces of the recessed portions 56, and the contact state can be maintained. A state where the protrusion portions 72 are fitted into the recessed portions 56 is visually recognizable in rear view.

In addition, when attachment of the substrate-side outer shell body 14 is completed, the press-fitting protrusion portion 75 is fitted into the recessed press-fitting portion 45 from below, and the contact ribs 68 of the press-fitting protrusion portion 75 come into contact with the inner surface on the opening side of the recessed press-fitting portion 45 in a compressed or crushed state. For this reason, the substrate-side outer shell body 14 is stably held in a state where inclination of the substrate-side outer shell body 14 with respect to the outer shell body 13 in the front-rear direction is restricted.

In addition, when attachment of the substrate-side outer shell body 14 is completed, the second coupling protrusion portions 76 are fitted into the fitting grooves 34 of the housing 18 (see FIG. 13), the pressing ribs 78 of the second coupling protrusion portions 76 come into contact with the front surfaces of the second locking protrusions 32, and the second coupling protrusion portions 76 are held on the housing 18 in a retained state.

Furthermore, when attachment of the substrate-side outer shell body 14 is completed, the back portion 61, the standing portion 62, and the partition portion 63 are fitted into the fitting receiving portion 39 of the outer shell body 13, and the engaging protrusion portions 49 of the substrate-side outer shell body 14 are fitted into the groove portions 51 of the outer shell body 13 (see FIG. 9), and the engaging protrusion portion 47 of the outer shell body 13 is fitted into the groove portion 52 of the substrate-side outer shell body 14. The contact ribs 65 to 68 of the substrate-side outer shell body 14 come into contact with corresponding surfaces such as the inner surfaces of the groove portions 51 of the outer shell body 13 and the outer surfaces of the engaging protrusion portion 47, in a compressed or crushed state. Accordingly, between the outer shell body 13 and the substrate-side outer shell body 14, a large number of electrical connection structures (contact point structures) are formed via the contact ribs 65 to 68. For this reason, it is possible to improve the reliability of electrical connection between the outer shell body 13 and the substrate-side outer shell body 14.

The contact ribs 65 to 68 are in contact with the corresponding surfaces of the outer shell body 13 in the up-down direction. For this reason, assuming that vibrational force in the up-down direction acts on the outer shell body 13 and the substrate-side outer shell body 14, it is possible to maintain a contact state of the contact ribs 65 to 68. In particular, in the first embodiment, a large number of contact ribs 65 to 68 are formed on the inner surfaces of the groove portion 52 of the substrate-side outer shell body 14 and the outer surfaces of the engaging protrusion portions 49, the engaging protrusion portions 49 of the substrate-side outer shell body 14 are fitted into the groove portions 51 of the outer shell body 13, the engaging protrusion portion 47 of the outer shell body 13 is fitted into the groove portion 52 of the substrate-side outer shell body 14, and thus the contact ribs 65 to 68 can reliably come into contact with corresponding surfaces of the outer shell body 13.

In a state where the outer shell body 13 and the substrate-side outer shell body 14 are attached, as shown in FIG. 2, the standing portion 62 is disposed so as to cover, from behind, the outer conductor tubes 15 disposed in the through holes 46, the short dielectric bodes 16, and the short inner conductors 12. In addition, the back portion 61 is disposed to cover, from behind, the outer conductor tubes 15 disposed in the upper through holes 46, the long dielectric bodies 17, and the long inner conductors 11. The drawer portions 102 of the inner conductors 11 and 12 are entirely surrounded by the outer conductors 13, 14, and 15, except for the substrate connection portions 107. Accordingly, attachment of the shield connector 10 is completed.

Next, the shield connector 10 is installed on the surface of the circuit substrate 200 (see FIGS. 2 and 8 to 10). The substrate connection portions 107 of the inner conductors 11 and 12 are inserted into the connection holes 202 of the circuit substrate 200, the leg portions 54 of the outer shell body 13 are inserted into the fixed holes 201 of the circuit substrate 200, and the mount portions 84 to 87 are placed on the lands of conductive portions of the circuit substrate 200. As a result of reflow-soldering being performed in this state, the substrate connection portions 107 of the inner conductors 11 and 12 are connected to conductive sections for signals, in the connection holes 202 of the circuit substrate 200, through soldering. In addition, the leg portions 54 are fixed to the fixed holes 201 through soldering, and the mount portions 84 to 87 are connected to conductive portions for the ground through soldering.

The inner conductors 11 and 12 are surrounded by the plurality of mount portions 84 to 87, on the bottom surface 92 of the substrate-side outer shell body 14. For this reason, crosstalk between the inner conductors 11 and 12 adjacent to each other in the width direction and the front-rear direction is suppressed. In addition, the recessed regression portion 88 that is recessed so as to separate away from the surface layer wiring of the circuit substrate 200 is formed in the substrate-side outer shell body 14, and thus it is possible to prevent the substrate-side outer shell body 14 from being electromagnetically coupled to the surface layer wiring.

Incidentally, when reflow-soldering is performed, reflow heat is transmitted from the outer surface of the substrate-side outer shell body 14 to the mount portions 84 to 87, and solder (paste solder) corresponding to the mount portions 84 to 87 is melted. In the first embodiment, in the substrate-side outer shell body 14, the depressed portion 91 is provided extending from the back surface 93 of the back portion 61 to the bottom surface 92, and the thickness of the partition portion 63 is reduced, and thus it is possible to reduce heat conductivity resistance, realizing high heat conductivity to the mount portions 84 to 87. In particular, the depressed portion 91 extends to the vicinity of the lateral mount portions 85 of the bottom surface 92 of the substrate-side outer shell body 14, and thus it is possible to effectively prevent the lateral mount portions 85 from entering an unsoldered state.

In addition, in the first embodiment, as shown in FIG. 10, a state where the lateral mount portions 85 are bonded to the conductive portions of the circuit substrate 200 through soldering (see the soldering fillet indicated by reference sign “b” in FIG. 10) can be confirmed through the opening of the back surface 93 of the depressed portion 91.

### Other Embodiments of Present Disclosure

Note that the embodiments disclosed herein are to be considered as illustrative and non-limiting in all aspects.

In the first embodiment above, the outer shell body is configured separately from the substrate-side outer shell body. However, according to another embodiment, an outer shell body may be formed integrally with a substrate-side outer shell body.

In the first embodiment above, the projection portions of the outer conductor tube include the contact protrusion portions. However, according to another embodiment, projection portions do not need to include contact protrusion portions. In this case, the side surfaces (plate surfaces) of the projection portions can be brought into contact with restriction portions of the outer shell body.

In the first embodiment above, the housing-side holding protrusion portions are formed on the housing. However, according to another embodiment, housing-side holding protrusion portions do not need to be formed on a housing. In this case, holding protrusion portions corresponding to the housing-side holding protrusion portions may be formed on the outer peripheral of each outer conductor tube.

### LIST OF REFERENCE NUMERALS

10 Shield connector
11 Long inner conductor (inner conductor)
12 Short inner conductor (inner conductor)
13 Outer shell body (outer conductor)
14 Substrate-side outer shell body (outer conductor)
15 Outer conductor tube (outer conductor)
16 Long dielectric body (dielectric body)
17 Short dielectric body (dielectric body)
18 Housing
19 Housing body
21 Hood
22 Insertion hole
23 Recessed fitting portion
24 In-recess rib
26 Punched recess portion
27 Fitting hole
28 First locking protrusion
31 Housing side portion
32 Second locking protrusion
34 Fitting groove
35 protrusion piece portion
36 Housing locking portion
37 Upper portion
38 Side portion
39 Fitting receiving portion
41 Mount portion
42 Tubular portion
43 First coupling protrusion portion
45 Recessed press-fitting portion
46 Through hole
47 Engaging protrusion portion of outer shell body (engaging protrusion portion)
49 Engaging protrusion portion of substrate-side outer shell body (engaging protrusion portion)
51 Groove portion of outer shell body (groove portion)
52 Groove portion of substrate-side outer shell body (groove portion)
54 Leg portion
56 Recessed portion
59 Bottom portion
61 Back portion (fitting portion)
62 Standing portion (fitting portion)
63 Partition portion (fitting portion)
65, 66, 67, 68 Contact rib
72 Protrusion portion
75 Press-fitting protrusion portion
76 Second coupling protrusion portion
78 Pressing rib
81 Opening portion
84 Front mount portion (mount portion)
85 Lateral mount portion (mount portion)
86 Shared mount portion (mount portion)
87 Complementary mount portion (mount portion)
88 Recessed regression portion
91 Depressed portion
92 Bottom surface
93 Back surface
94 Cylindrical connection portion
95 Projection portion
101 Main body portion
102 Drawer portion
103 Guide groove
104 Horizontal portion
105 Extended portion
106 Partner connection portion
107 Substrate connection portion
108 Housing-side holding protrusion portion
109 End surface
111 Cut groove
112 Stopper portion
113 Restriction portion
116 Butt edge
117 Contact protrusion portion
118 Press-fitting blade
119 Slit
120 Inner-side protrusion
121 Holding protrusion portion
126 Inner and farther surface
127 Inner and upper surface
200 Circuit substrate
201 Fixed hole
202 Connection hole
300 Partner connector
301 Space portion
303 Partner inner conductor
311 Partner outer conductor

1. A shield connector comprising:
an inner conductor; an outer conductor that surrounds the inner conductor; and a dielectric body disposed between the inner conductor and the outer conductor,
wherein the outer conductor includes a bottom surface, a back surface intersecting the bottom surface, a mount portion formed on the bottom surface and bonded to a surface of a circuit substrate through soldering, and a depressed portion provided in an area extending from the back surface to the bottom surface and disposed in the bottom surface in the vicinity of the mount portion.

2. The shield connector according to claim 1,
wherein a plurality of the inner conductors are provided,
the outer conductor includes a back portion that includes the back surface, and a partition portion that is continuous to the back portion, and
the partition portion is disposed between the inner conductors adjacent to each other, and has the depressed portion defined therein.

3. The shield connector according to claim 1,
wherein the mount portion is disposed so as to be visually recognizable through the depressed portion, in rear view of the outer conductor.
